(19) United States
(12) Patent Application Publication
(10) Pub. No.: US 2026/0217302 A1
(43) Pub. Date: Jul. 30, 2026

(54) FULL-VECTOR CHASSIS SEMI-DECOUPLED STEERING TRANSVERSE TIE ROD STRUCTURE AND EXECUTION CONTROL METHOD THEREOF

(71) Applicant: TSINGHUA UNIVERSITY, Beijing (CN)

(72) Inventors: Xiangyu WANG, Beijing (CN); Liang LI, Beijing (CN); Yicai LIU, Beijing (CN); Quantong LI, Beijing (CN); Qi ZHANG, Beijing (CN)

(21) Appl. No.: 19/457,215

(22) Filed: Jan. 23, 2026

(30) Foreign Application Priority Data
Jan. 26, 2025 (CN) 202510122684.0

(51) Int. Cl. B62D 3/12; B62D 7/16; B62D 7/18

(52) U.S. Cl. CPC B62D 3/12; B62D 7/163; B62D 7/166; B62D 7/18

(57) ABSTRACT

The present disclosure provides a full-vector chassis semi-decoupled steering transverse tie rod structure and an execution control method thereof. The full-vector chassis semi-decoupled steering transverse tie rod structure includes: a housing; a first rack; a first steering tie rod connected to the first rack and a steering knuckle of a first corner module, respectively; a first pinion meshed with the first rack; a second rack arranged in parallel with and spaced apart from the first rack; a second steering tie rod connected to the second rack and a steering knuckle of a second corner module, respectively; a second pinion meshed with the second rack; and a clutch device. When the clutch device is in an engaged state, the clutch device connects the first pinion to the second pinion, to enable the first pinion and the second pinion to rotate synchronously, and when the clutch device is in a disengaged state, the clutch device disconnects the first pinion from the second pinion. The full-vector chassis semi-decoupled steering transverse tie rod structure according to the present disclosure offers advantages such as excellent high-speed stability, strong low-speed maneuverability, high fault tolerance, a wide steering range, a simple structure, etc.

### FIELD

The present disclosure relates to the field of vehicle engineering technologies, and more particularly, to a full-vector chassis semi-decoupled steering transverse tie rod structure and an execution control method thereof.

### BACKGROUND

With the continuous advancement of automotive technology, a drive-by-wire chassis that eliminates mechanical connections via electrical signals is gradually replacing a traditional mechanical chassis, and has become a key technology for autonomous driving vehicles. Drive-by-wire steering systems mostly focus on decoupling control and actuation mechanisms, while a full-vector drive-by-wire chassis further decouples actuation functions to individual wheels, enabling three mutually independent force vectors of each wheel, that is, longitudinal force, lateral force, and vertical force, to be all independently controllable. This new type of chassis can meet requirements of high-level autonomous driving and various special application scenarios (such as battlefield operations, natural disaster rescue, etc.) for an automotive chassis. A corner module is a basic structural unit of the full-vector drive-by-wire chassis, and integrates functions of driving, braking, steering, and suspension into a single module.

In the related art, the full-vector drive-by-wire chassis fails to achieve both maneuverability and stability, and has poor fault tolerance.

### SUMMARY

The present disclosure aims to solve at least one of the technical problems in the related art. To this end, the present disclosure provides a full-vector chassis semi-decoupled steering transverse tie rod structure, which offers advantages such as excellent high-speed stability, strong low-speed maneuverability, high fault tolerance, a wide steering range, a simple structure, etc.

The present disclosure further provides an execution control method having the full-vector chassis semi-decoupled steering transverse tie rod structure.

To achieve the above objective, an embodiment of a first aspect of the present disclosure provides a full-vector chassis semi-decoupled steering transverse tie rod structure. The full-vector chassis semi-decoupled steering transverse tie rod structure includes: a housing; a first rack having a length direction oriented in a left-right direction, the first rack being disposed at the housing and movable left and right; a first steering tie rod rotatably connected to the first rack and a steering knuckle of a first corner module, respectively, where the first corner module is provided with a first steering drive device and a first braking device; a first pinion rotatably disposed at the housing and meshed with the first rack; a second rack having a length direction oriented in the left-right direction, the second rack being disposed at the housing and movable left and right, and the second rack being arranged parallel to and spaced apart from the first rack; a second steering tie rod rotatably connected to the second rack and a steering knuckle of a second corner module, respectively, where the second corner module is provided with a second steering drive device and a second braking device; a second pinion rotatably disposed at the housing and meshed with the second rack; and a clutch device having a disengaged state and an engaged state, where: when the clutch device is in the engaged state, the clutch device connects the first pinion to the second pinion, to enable the first pinion and the second pinion to rotate synchronously, and when the clutch device is in the disengaged state, the clutch device disconnects the first pinion from the second pinion.

The full-vector chassis semi-decoupled steering transverse tie rod structure according to the embodiments of the present disclosure offers the advantages such as excellent high-speed stability, strong low-speed maneuverability, high fault tolerance, a wide steering range, a simple structure, etc.

In addition, the full-vector chassis semi-decoupled steering transverse tie rod structure according to the above embodiments of the present disclosure may further have the following additional technical features.

According an embodiment of the present disclosure, the clutch device includes: a first clutch member disposed at the first pinion and axially movable between a disengaged position and an engaged position, the first clutch member rotating along with the first pinion; and a second clutch member disposed at the second pinion. When the first clutch member is located at the engaged position, the first clutch member is connected to the second clutch member and rotates along with the second clutch member, and when the first clutch member is located at the disengaged position, the first clutch member is disconnected from the second clutch member.

According to an embodiment of the present disclosure, the first clutch member and the first pinion are coaxially arranged. The second clutch member and the second pinion are coaxially arranged.

According to an embodiment of the present disclosure, the first clutch member has first clutch teeth at an end face of the first clutch member. The second clutch member has second clutch teeth at an end face of the second clutch member. When the first clutch member is located at the engaged position, the first clutch teeth are meshed with the second clutch teeth.

According to an embodiment of the present disclosure, the first steering tie rod includes a first inner steering tie rod rotatably connected to an end of the first rack at an end of the first inner steering tie rod and a first outer steering tie rod threadedly engaged with the other end of the first inner steering tie rod at an end of the first outer steering tie rod, where the first outer steering tie rod is rotatably connected to the steering knuckle of the first corner module at the other end of the first outer steering tie rod. The second steering tie rod includes a second inner steering tie rod rotatably connected to an end of the second rack at an end of the second inner steering tie rod and a second outer steering tie rod threadedly engaged with the other end of the second inner steering tie rod at an end of the second outer steering tie rod, where the second outer steering tie rod is rotatably connected to the steering knuckle of the second corner module at the other end of the second outer steering tie rod.

According to an embodiment of the present disclosure, each of the first pinion and the second pinion is a helical pinion. Each of the first rack and the second rack is a helical rack.

According to an embodiment of the present disclosure, dust boots are disposed between the housing and the first steering tie rod and between the housing and the second steering tie rod.

An embodiment of a second aspect of the present disclosure provides an execution control method for the full-vector chassis semi-decoupled steering transverse tie rod structure according to the embodiments of the first aspect of the present disclosure. The execution control method includes: obtaining a traveling speed of a vehicle; detecting that the traveling speed is greater than or equal to a predetermined value, and controlling the clutch device to switch to the engaged state in response to detecting that the traveling speed is greater than or equal to the predetermined value; and detecting that the traveling speed is less than the predetermined value, and controlling the clutch device to switch to the disengaged state in response to detecting that the traveling speed is less than the predetermined value.

The execution control method for the full-vector chassis semi-decoupled steering transverse tie rod structure according to the embodiments of the present disclosure, by adopting the full-vector chassis semi-decoupled steering transverse tie rod structure according to the embodiments of the first aspect of the present disclosure, offers the advantages such as excellent high-speed stability, strong low-speed maneuverability, high fault tolerance, a wide steering range, a simple structure, etc.

According to an embodiment of the present disclosure, the execution control method for the full-vector chassis semi-decoupled steering transverse tie rod structure further includes: obtaining an operating state of the first steering drive device and an operating state of the second steering drive device; and detecting that either the first steering drive device or the second steering drive device fails, and controlling the clutch device to switch to the engaged state in response to detecting that either the first steering drive device or the second steering drive device fails.

According to an embodiment of the present disclosure, the execution control method for the full-vector chassis semi-decoupled steering transverse tie rod structure further includes: obtaining a braking state of the vehicle; and detecting that the braking state is in a toe-in active braking state of wheels, and controlling the clutch device to switch to the engaged state in response to detecting that the braking state is in the toe-in active braking state of wheels.

Additional aspects and advantages of the present disclosure will be provided in part in the following description, or will become apparent in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic structural view of a full-vector chassis semi-decoupled steering transverse tie rod structure, a first corner module, and a second corner module according to an embodiment of the present disclosure.

FIG. 2 is a schematic structural view of a full-vector chassis semi-decoupled steering transverse tie rod structure according to an embodiment of the present disclosure.

FIG. 3 is an exploded view of a full-vector chassis semi-decoupled steering transverse tie rod structure according to an embodiment of the present disclosure.

FIG. 4 is a schematic view of an execution control method for a full-vector chassis semi-decoupled steering transverse tie rod structure according to an embodiment of the present disclosure.

Reference numerals in the accompanying drawings: full-vector chassis semi-decoupled steering transverse tie rod structure 1, first rack 10, first steering tie rod 20, first inner steering tie rod 21, first outer steering tie rod 22, first pinion 30, second rack 40, second steering tie rod 50, second inner steering tie rod 51, second outer steering tie rod 52, second pinion 60, clutch device 70, first clutch member 71, second clutch member 72, first corner module 2, second corner module 3.

### DETAILED DESCRIPTION OF THE EMBODIMENTS

The present disclosure is made based on discoveries and understandings of the inventor regarding the following facts and problems.

In the related art, a full-vector drive-by-wire chassis fails to achieve both maneuverability and stability, and has poor fault tolerance.

To be specific, the full-vector drive-by-wire chassis is prone to problems such as wheel shimmy and asynchronous left-right steering due to independent execution of driving, braking, steering, and other functions by each corner module, affecting stability of a vehicle. If two corner modules are connected to achieve axial steering, maneuverability of the vehicle may be affected. In addition, if partial functions of the corner module fail, the chassis may have poor redundant fault tolerance.

In addition, for partial steering systems in the related art, a steering motor is connected to a rack-pinion mechanism through a commutator, and a rack is then connected to wheels to achieve steering. Commutators for a same set of wheels are connected or disconnected through a clutch to realize synchronous steering or independent steering. On the one hand, such steering systems are not used in the full-vector drive-by-wire chassis. The steering motor of such systems drives the rack-pinion mechanism and then drives the wheels to realize steering, and is not independently mounted at the corner module, which constitutes a key difference from the full-vector drive-by-wire chassis addressed in the present disclosure. On the other hand, such steering systems adopt the commutator to achieve transmission between the clutch, the steering motor, and the rack-pinion mechanism, which leads to a complex structure, a large number of transmission steps, and poor stability.

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In the description of the present disclosure, it should be understood that the orientation or the position indicated by terms such as “center”, “longitudinal”, “lateral”, “length”, “width”, “thickness”, “over”, “below”, “front”, “rear”, “left”, “right”, “vertical”, “lateral”, “top”, “bottom”, “inner”, “outer”, “clockwise”, “anti-clockwise”, “axial”, “radial”, and “circumferential” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure. In addition, the features associated with “first” and “second” may explicitly or implicitly include at least one of the features. In the description of the present disclosure, “plurality” means at least two, unless otherwise specifically defined.

In the description of the present disclosure, it should be noted that, unless otherwise clearly specified and limited, terms such as “install”, “connect”, “connect to”, and the like should be understood in a broad sense. For example, it may be a fixed connection or a detachable connection or connection as one piece, mechanical connection or electrical connection, direct connection or indirect connection through an intermediate, internal communication of two components or the interaction relationship between two components. For those skilled in the art, the specific meaning of the above-mentioned terms in the present disclosure can be understood according to specific circumstances.

A full-vector chassis semi-decoupled steering transverse tie rod structure 1 according to the embodiments of the present disclosure will be described below in conjunction with the accompanying drawings.

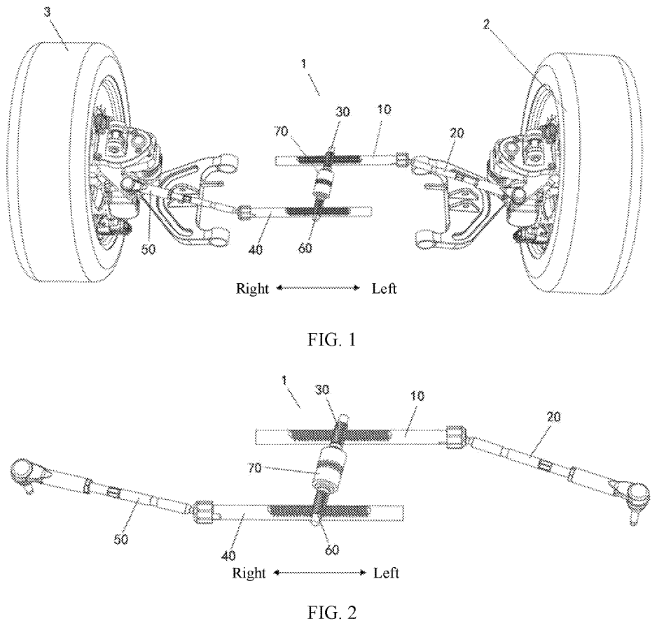

As illustrated in FIG. 1 to FIG. 4, the full-vector chassis semi-decoupled steering transverse tie rod structure 1 according to the embodiments of the present disclosure includes a housing (not illustrated in the figure), a first rack 10, a first steering tie rod 20, a first pinion 30, a second rack 40, a second steering tie rod 50, a second pinion 60, and a clutch device 70.

The first rack 10 has a length direction oriented in a left-right direction (the left-right direction is indicated by an arrow in the figure). The first rack 10 is disposed at the housing and movable left and right. The first steering tie rod 20 is rotatably connected to the first rack 10 and a steering knuckle of a first corner module 2, respectively. The first corner module 2 is provided with a first steering drive device and a first braking device. The first pinion 30 is rotatably disposed at the housing and meshed with the first rack 10.

The second rack 40 has a length direction oriented in the left-right direction. The second rack 40 is disposed at the housing and movable left and right. The second rack 40 is arranged in parallel with and spaced apart from the first rack 10. The second steering tie rod 50 is rotatably connected to the second rack 40 and a steering knuckle of a second corner module 3, respectively. The second corner module 3 is provided with a second steering drive device and a second braking device. The second pinion 60 is rotatably disposed at the housing and meshed with the second rack 40.

The clutch device 70 has a disengaged state and an engaged state. When the clutch device 70 is in the engaged state, the clutch device 70 connects the first pinion 30 to the second pinion 60, to enable the first pinion 30 and the second pinion 60 to rotate synchronously. When the clutch device 70 is in the disengaged state, the clutch device 70 disconnects the first pinion 30 from the second pinion 60.

To be specific, steering drive of the first steering drive device for the first corner module 2 is transmitted to the first rack 10 through the first steering tie rod 20, and further transmitted to the first pinion 30 through meshing engagement between the first rack 10 and the first pinion 30. Steering drive of the second steering drive device for the second corner module 3 is transmitted to the second rack 40 through the second steering tie rod 50, and further transmitted to the second pinion 60 through meshing engagement between the second rack 40 and the second pinion 60.

When the clutch device 70 is in the disengaged state, the first pinion 30 and the second pinion 60 are disconnected from each other and are able to rotate relative to each other. In this case, a steering driving force of the first corner module 2 and a steering driving force of the second corner module 3 are not transmitted to each other through the clutch device 70, and thus the first corner module 2 and the second corner module 3 may steer independently without mutual interference. When the clutch device 70 is in the engaged state, the first pinion 30 is connected to the second pinion 60 through the clutch device 70, to enable the first pinion 30 and the second pinion 60 to rotate synchronously. In this case, the steering driving force of the first corner module 2 and the steering driving force of the second corner module 3 are transmitted to each other through the clutch device 70, in such a manner that steering movement of the first corner module 2 and steering movement of the second corner module 3 can affect each other, forming an axial steering mode. Also, the first steering drive device and the second steering drive device may serve as mutual redundancy.

For example, as illustrated in (a) of FIG. 4, when the vehicle is traveling at a to medium speed, steering angles of left and right wheels may be large. To ensure the maneuverability of the vehicle, the clutch device 70 may be controlled to switch to the disengaged state, in such a manner that the steering movement of the first corner module 2 and the steering movement of the second corner module 3 do not affect each other.

As illustrated in (b) of FIG. 4, when the vehicle is traveling at a high speed, the steering angles of the left and right wheels are generally small. To ensure the stability of the vehicle, the clutch device 70 may be controlled to switch to the engaged state, in such a manner that lateral movement of the first rack 10 and lateral movement of the second rack 40 are consistent in displacement and opposite in direction, and the steering movement of the first corner module 2 and the steering movement of the second corner module 3 are coupled to convert into the axial steering mode. On the one hand, rigidity of an entire steering system can be ensured to prevent wheel shimmy issues. On the other hand, coupling of the first corner module 2 and the second corner module 3 may ensure movement coordination of the first corner module 2 and the second corner module 3 under high-frequency steering, improving overall stability of the vehicle. Also, the first steering drive device and the second steering drive device may serve as mutual redundancy. When either the first steering drive device or the second steering drive device fails, the other can be used to achieve steering drive, thus improving the fault tolerance of the entire system.

As illustrated in (c) of FIG. 4, when either the first steering drive device or the second steering drive device fails, the figure illustrates an example where a steering drive device of one of two rear corner modules of the vehicle fails. In this case, the clutch device 70 may be controlled to switch to the engaged state, and a non-failed steering drive device may drive a failed steering drive device to achieve steering through the full-vector chassis semi-decoupled steering transverse tie rod structure 1.

As illustrated in (d) of FIG. 4, when the vehicle needs to perform toe-in active braking of wheels, i.e., the left wheels steer right while the right wheels steer left, for example, when both the first braking device and the second braking device fail and thus cause a significant deterioration in braking performance of the vehicle, structural strength and rigidity of a single corner module can be insufficient to achieve toe-in active braking by relying solely on its own steering drive device. In this case, after the wheels are rotated to be in a toe-in active braking state, the clutch device 70 may be controlled to switch to the engaged state to enhance the rigidity and the strength of the system, improving a braking effect.

According to the full-vector chassis semi-decoupled steering transverse tie rod structure 1 in the embodiments of the present disclosure, by providing the first rack 10, the first steering tie rod 20, the first pinion 30, the second rack 40, the second steering tie rod 50, and the second pinion 60, steering drive of the first corner module 2 can be transmitted to the first rack 10 through the first steering tie rod 20, and further transmitted to the first pinion 30 through the meshing engagement between the first rack 10 and the first pinion 30. Steering drive of the second corner module 3 can be transmitted to the second rack 40 through the second steering tie rod 50, and further transmitted to the second pinion 60 through the meshing engagement between the second rack 40 and the second pinion 60. In addition, by providing the clutch device 70, the clutch device 70 is configured to have the disengaged state and the engaged state. When the clutch device 70 is in the disengaged state, the first pinion 30 and the second pinion 60 are disconnected from each other and are able to rotate relative to each other. In this case, the steering driving force of the first corner module 2 and the steering driving force of the second corner module 3 are not transmitted to each other through the clutch device 70, thus the first corner module 2 and the second corner module 3 may steer independently without the mutual interference. When the clutch device 70 is in the engaged state, the first pinion 30 is connected to the second pinion 60 through the clutch device 70, to enable the first pinion 30 and the second pinion 60 to rotate synchronously. In this case, the steering driving force of the first corner module 2 and the steering driving force of the second corner module 3 are transmitted to each other through the clutch device 70, in such a manner that the steering movement of the first corner module 2 and the steering movement of the second corner module 3 can affect each other, forming the axial steering mode. Also, the first steering drive device and the second steering drive device may serve as the mutual redundancy.

Thus, when the clutch device 70 is disconnected, the first corner module 2 and the second corner module 3 steer independently of each other, which corresponds to an independent steering mode and improves the maneuverability of the vehicle. When the clutch device 70 is engaged, the first corner module 2 and the second corner module 3 may form a traditional axial steering mode, which ensures the high-speed stability of the vehicle. In this way, while enhancing the rigidity of the steering system, the first corner module 2 and the second corner module 3 may serve as the mutual redundancy, ensuring the fault tolerance after a steering failure or a braking failure.

In addition, by adopting the configuration where the rack is connected to the steering knuckle using the tie rod, the rack is meshed with the pinion, and the pinions are connected through the clutch, and with the second rack 40 arranged in parallel with and spaced apart from the first rack 10, not only is lateral movement of the rack converted into rotation of the pinion, but also mutual interference between the racks is prevented. Thus, a steering range of the corner module is prevented from being affected, expanding the steering range. Further, comparing with commutator-connected configuration adopted in the related art, the structure is simpler and the stability is higher.

Therefore, the full-vector chassis semi-decoupled steering transverse tie rod structure 1 according to the embodiments of the present disclosure offers the advantages such as excellent high-speed stability, strong low-speed maneuverability, high fault tolerance, a wide steering range, a simple structure, etc.

The full-vector chassis semi-decoupled steering transverse tie rod structure 1 according to the specific embodiments of the present disclosure will be described below in conjunction with the accompanying drawings.

In some specific embodiments of the present disclosure, as illustrated in FIG. 1 to FIG. 4, the full-vector chassis semi-decoupled steering transverse tie rod structure 1 according to the embodiments of the present disclosure includes the housing, the first rack 10, the first steering tie rod 20, the first pinion 30, the second rack 40, the second steering tie rod 50, the second pinion 60, and the clutch device 70.

In an exemplary embodiment of the present disclosure, as illustrated in FIG. 1 to FIG. 3, the clutch device 70 includes a first clutch member 71 and a second clutch member 72. The first clutch member 71 is disposed at the first pinion 30 and axially movable between a disengaged position and an engaged position. The first clutch member 71 rotates along with the first pinion 30. The second clutch member 72 is disposed at the second pinion 60. When the first clutch member 71 is located at the engaged position, the first clutch member 71 is connected to the second clutch member 72 and rotates along with the second clutch member 72, and when the first clutch member 71 is located at the disengaged position, the first clutch member 71 is disconnected from the second clutch member 72. To be specific, when the clutch device 70 is in the disengaged state, the first clutch member 71 is located at the disengaged position, and when the clutch device 70 is in the engaged state, the first clutch member 71 is located at the engaged position. The clutch device 70 may be an electromagnetic clutch device and driven by an electromagnet and a spring. In this way, through movement of the first clutch member 71, engagement or disengagement of the clutch device 70 can be achieved. Also, the clutch member is directly disposed at the pinion, which can reduce transmission processes, further improving the stability.

In an exemplary embodiment of the present disclosure, as illustrated in FIG. 1 to FIG. 3, the first clutch member 71 and the first pinion 30 are coaxially arranged. The second clutch member 72 and the second pinion 60 are coaxially arranged. In this way, the stability of the full-vector chassis semi-decoupled steering transverse tie rod structure 1 can be further improved.

Further, as illustrated in FIG. 1 to FIG. 3, the first clutch member 71 has first clutch teeth at an end face of the first clutch member 71. The second clutch member 72 has second clutch teeth at an end face of the second clutch member 72. When the first clutch member 71 is located at the engaged position, the first clutch teeth are meshed with the second clutch teeth. In this way, the first clutch member 71 is facilitated to drive the second clutch member 72 to rotate synchronously when the first clutch member 71 is located at the engaged position.

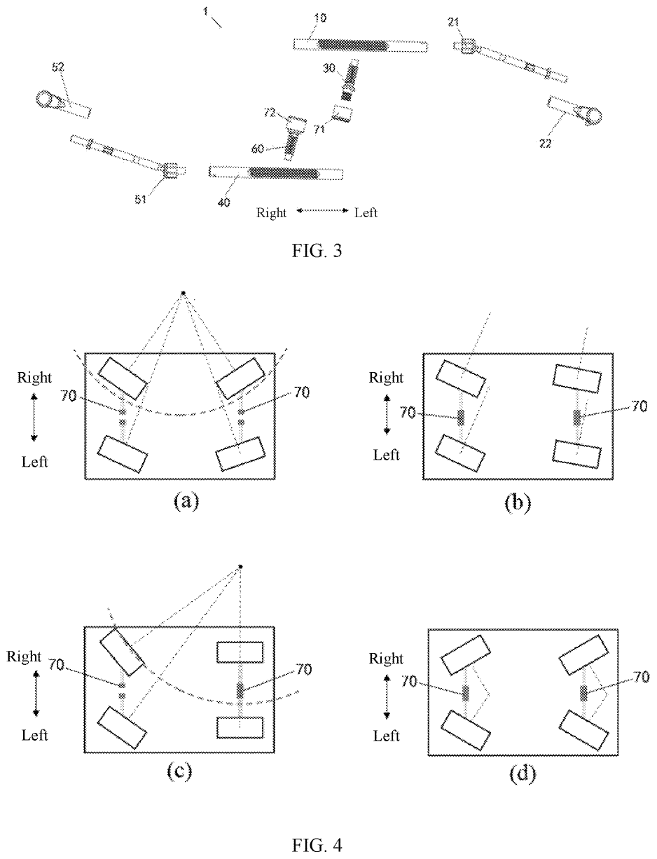

FIG. 3 illustrates the full-vector chassis semi-decoupled steering transverse tie rod structure 1 according to some embodiments of the present disclosure. As illustrated in FIG. 3, the first steering tie rod 20 includes a first inner steering tie rod 21 and a first outer steering tie rod 22. The first inner steering tie rod 21 is rotatably connected to an end of the first rack 10 at an end of the first inner steering tie rod 21. The first outer steering tie rod 22 is threadedly engaged with the other end of the first inner steering tie rod 21 at an end of the first outer steering tie rod 22. The first outer steering tie rod 22 is rotatably connected to the steering knuckle of the first corner module 2 at the other end of the first outer steering tie rod 22. To be specific, the first inner steering tie rod 21 is connected to the first rack 10 through a ball joint bearing, and the first outer steering tie rod 22 is connected to the steering knuckle of the first corner module 2 through a rod end bearing.

The second steering tie rod 50 includes a second inner steering tie rod 51 and second outer steering tie rod 52. The second inner steering tie rod 51 is rotatably connected to an end of the second rack 40 at an end of the second inner steering tie rod 51. The second outer steering tie rod 52 is threadedly engaged with the other end of the second inner steering tie rod 51 at an end of the second outer steering tie rod 52. The second outer steering tie rod 52 is rotatably connected to the steering knuckle of the second corner module 3 at the other end of the second outer steering tie rod 52. To be specific, the second inner steering tie rod 51 is connected to the second rack 40 through a ball joint bearing, and the second outer steering tie rod 52 is connected to the steering knuckle of the second corner module 3 through a rod end bearing.

In this way, arrangement of the first steering tie rod 20 and the second steering tie rod 50 is facilitated, facilitating adjusting a length of the first steering tie rod 20 and a length of the second steering tie rod 50.

In another exemplary embodiment of the present disclosure, each of the first pinion 30 and the second pinion 60 is a helical pinion. Each of the first rack 10 and the second rack 40 is a helical rack. In this way, smother transmission between the pinions and the racks is achieved.

Beneficially, dust boots are disposed between the housing and the first steering tie rod 20 and between the housing and the second steering tie rod 50. In this way, dust is prevented from entering the housing, and lubricating performance of all structures inside the housing is ensured.

An execution control method for the full-vector chassis semi-decoupled steering transverse tie rod structure 1 according to the above embodiments of the present disclosure will be described below.

The execution control method includes: obtaining a traveling speed of the vehicle; detecting that the traveling speed is greater than or equal to a predetermined value, and controlling the clutch device 70 to switch to the engaged state in response to detecting that the traveling speed is greater than or equal to the predetermined value; and detecting that the traveling speed is less than the predetermined value, and controlling the clutch device 70 to switch to the disengaged state in response to detecting that the traveling speed is less than the predetermined value.

The execution control method for the full-vector chassis semi-decoupled steering transverse tie rod structure 1 according to the embodiments of the present disclosure, by adopting the full-vector chassis semi-decoupled steering transverse tie rod structure 1 according to the above embodiments of the present disclosure, offers the advantages such as excellent high-speed stability, strong low-speed maneuverability, high fault tolerance, a wide steering range, a simple structure, etc.

Beneficially, the execution control method for the full-vector chassis semi-decoupled steering transverse tie rod structure 1 further includes: obtaining an operating state of the first steering drive device and an operating state of the second steering drive device; and detecting that either the first steering drive device or the second steering drive device fails, and controlling the clutch device 70 to switch to the engaged state in response to detecting that either the first steering drive device or the second steering drive device fails.

More beneficially, the execution control method for the full-vector chassis semi-decoupled steering transverse tie rod structure 1 further includes: obtaining a braking state of the vehicle; and detecting that the braking state is in a toe-in active braking state of wheels, and controlling the clutch device 70 to switch to the engaged state in response to detecting that the braking state is in the toe-in active braking state of wheels.

Thus, under medium and low-speed operating conditions, the clutch device 70 is disconnected to enable the steering movement of the first corner module 2 and the steering movement of the second corner module 3 to be independent of each other, improving the low-speed maneuverability of the vehicle. Under high-speed operating conditions, the clutch device 70 is engaged, and the first corner module 2 and the second corner module 3 form the traditional axial steering mode, ensuring the high-speed stability of the vehicle, and preventing influences of the wheel shimmy and the asynchronous left-right steering on the stability of the vehicle. When a steering function of one of the first corner module 2 and the second corner module 3 fails, the corner module with the non-failed steering function may control the other steering-failed corner module through the full-vector chassis semi-decoupled steering transverse tie rod structure 1, thus achieving the mutual redundancy between the first corner module 2 and the second corner module 3. When the vehicle needs to perform the toe-in active braking of wheels, for example, when both the first braking device and the second braking device fail and thus cause the significant deterioration in the braking performance of the vehicle, the clutch device 70 may be switched to the engaged state after the braking state is in the toe-in active braking state of wheels, to enhance the rigidity and the strength of the system, and improve the braking effect.

Other components and operations of the full-vector chassis semi-decoupled steering transverse tie rod structure 1 and the execution control method thereof according to the embodiments of the present disclosure are known to those skilled in the art, which will not be described in detail herein.

Reference throughout this specification to, “an embodiment”, “some embodiments”, “schematic embodiments”, “an example”, “a specific example”, or “some examples” means that a particular feature, structure, material, or characteristic described in connection with the embodiment or example is included in at least one embodiment or example of the present disclosure. In this specification, exemplary descriptions of above terms are not necessarily referring to the same embodiment or example. Further, the particular features, structures, materials, or characteristics can be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A full-vector chassis semi-decoupled steering transverse tie rod structure, comprising:
a housing;
a first rack having a length direction oriented in a left-right direction, the first rack being disposed at the housing and movable left and right;
a first steering tie rod rotatably connected to the first rack and a steering knuckle of a first corner module, respectively, wherein the first corner module is provided with a first steering drive device and a first braking device;
a first pinion rotatably disposed at the housing and meshed with the first rack;
a second rack having a length direction oriented in the left-right direction, the second rack being disposed at the housing and movable left and right, and the second rack being arranged in parallel with and spaced apart from the first rack;
a second steering tie rod rotatably connected to the second rack and a steering knuckle of a second corner module, respectively, wherein the second corner module is provided with a second steering drive device and a second braking device;
a second pinion rotatably disposed at the housing and meshed with the second rack; and
a clutch device having a disengaged state and an engaged state, wherein:
when the clutch device is in the engaged state, the clutch device connects the first pinion to the second pinion, to enable the first pinion and the second pinion to rotate synchronously; and
when the clutch device is in the disengaged state, the clutch device disconnects the first pinion from the second pinion.

2. The full-vector chassis semi-decoupled steering transverse tie rod structure according to claim 1, wherein the clutch device comprises:
a first clutch member disposed at the first pinion and axially movable between a disengaged position and an engaged position, the first clutch member rotating along with the first pinion; and
a second clutch member disposed at the second pinion, wherein:
when the first clutch member is located at the engaged position, the first clutch member is connected to the second clutch member and rotates along with the second clutch member; and
when the first clutch member is located at the disengaged position, the first clutch member is disconnected from the second clutch member.

3. The full-vector chassis semi-decoupled steering transverse tie rod structure according to claim 2, wherein:
the first clutch member and the first pinion are coaxially arranged; and
the second clutch member and the second pinion are coaxially arranged.

4. The full-vector chassis semi-decoupled steering transverse tie rod structure according to claim 2, wherein:
the first clutch member has first clutch teeth at an end face of the first clutch member; and
the second clutch member has second clutch teeth at an end face of the second clutch member,
wherein when the first clutch member is located at the engaged position, the first clutch teeth are meshed with the second clutch teeth.

5. The full-vector chassis semi-decoupled steering transverse tie rod structure according to claim 1, wherein:
the first steering tie rod comprises a first inner steering tie rod rotatably connected to an end of the first rack at an end of the first inner steering tie rod and a first outer steering tie rod threadedly engaged with the other end of the first inner steering tie rod at an end of the first outer steering tie rod, wherein the first outer steering tie rod is rotatably connected to the steering knuckle of the first corner module at the other end of the first outer steering tie rod; and
the second steering tie rod comprises a second inner steering tie rod rotatably connected to an end of the second rack at an end of the second inner steering tie rod and a second outer steering tie rod threadedly engaged with the other end of the second inner steering tie rod at an end of the second outer steering tie rod, wherein the second outer steering tie rod is rotatably connected to the steering knuckle of the second corner module at the other end of the second outer steering tie rod.

6. The full-vector chassis semi-decoupled steering transverse tie rod structure according to claim 1, wherein:
each of the first pinion and the second pinion is a helical pinion; and
each of the first rack and the second rack is a helical rack.

7. The full-vector chassis semi-decoupled steering transverse tie rod structure according to claim 1, wherein dust boots are disposed between the housing and the first steering tie rod and between the housing and the second steering tie rod.

8. An execution control method for the full-vector chassis semi-decoupled steering transverse tie rod structure according to any one of claims 1 to 7, comprising:
obtaining a traveling speed of a vehicle;
detecting that the traveling speed is greater than or equal to a predetermined value, and controlling the clutch device to switch to the engaged state in response to detecting that the traveling speed is greater than or equal to the predetermined value; and
detecting that the traveling speed is less than the predetermined value, and controlling the clutch device to switch to the disengaged state in response to detecting that the traveling speed is less than the predetermined value.

9. The execution control method for the full-vector chassis semi-decoupled steering transverse tie rod structure according to claim 8, further comprising:
obtaining an operating state of the first steering drive device and an operating state of the second steering drive device; and
detecting that either the first steering drive device or the second steering drive device fails, and controlling the clutch device to switch to the engaged state in response to detecting that either the first steering drive device or the second steering drive device fails.

10. The execution control method for the full-vector chassis semi-decoupled steering transverse tie rod structure according to claim 8, further comprising:
obtaining a braking state of the vehicle; and
detecting that the braking state is in a toe-in active braking state of wheels, and controlling the clutch device to switch to the engaged state in response to detecting that the braking state is in the toe-in active braking state of wheels.
